(19) United States
(12) Patent Application Publication
(10) Pub. No.: US 2009/0056097 A1
(43) Pub. Date: Mar. 5, 2009

(54) Assembly and disassembly device for display monitor and method thereof

(76) Inventors: Cheng Ho Huang, Taipei City (TW); Hung Lin Chang, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,228

(22) Filed: Jan. 23, 2008

(30) Foreign Application Priority Data
Sep. 3, 2007 (TW) 096132812

(51) Int. Cl. B23P 19/00

(52) U.S. Cl. 29/426.1; 29/729; 29/762; 29/428

(57) ABSTRACT

An assembly and disassembly device for a display monitor and a method are disclosed. The assembly and disassembly device of the present invention is used to assemble the display monitor to a seat and to disassemble the display monitor from the seat body. The assembly and disassembly device of the present invention comprises a lockup portion connected to the seat body and a framework portion connected to the display monitor. The lockup portion has at least a locking body, and the framework portion has a connecting body. The fastening body has an opening and a guiding slot, and the opening is connected with the guiding slot. When the locking body moves from the opening to the guiding slot, the lockup portion can be securely fastened to the framework portion, thereby installing the display monitor to the seat body.

### FIELD OF THE INVENTION

The present invention relates to an assembly and disassembly device and method thereof, and more particularly to a technique field that can rapidly assemble/disassemble a display monitor from a seat body.

### DESCRIPTION OF THE PRIOR ART

Referring to FIG. 1, a perspective view of a conventional pivot device for a display monitor is illustrated. An electronic device includes a display monitor 12 and a seat body 11, and the display monitor 12 is connected to the seat body 11 through the pivot device. The pivot device has a lockup portion 13 and a framework portion 14. The lockup portion 13 has a locking body 131, a joint portion 132, a locking hole 133, a connection body 134 and a locking hole 135. The framework portion 14 is disposed on the display monitor 12, and has a joint lever 141. The joint portion 132 is extended from the locking body 131, and connected with the joint lever 141. The connecting body 134 is located below the locking body 131, and has a locking hole 135. The locking hole 133 is located on the locking body 131. When the display monitor 12 is connected to the seat body 11, the lockup portion 13 is placed in the seat body 11, and screws are screwed to the locking hole 133 and the locking hole 135. The framework portion 14 then is assembled to the display monitor 12 so as to connect the display monitor 12 and the seat body 11.

However, when the display monitor 12 is assembled to the seat body 11, many screws must be utilized; also, when the display monitor 12 needs to be repaired due to damage, the display monitor 12 must be disassembled from the seat body 11, resulting in taking a long time. Therefore, in order to improve the efficiency of assembling and repairing notebook computers, the problem of quickly assembling and dissembling the display monitor from the seat body of the notebook computers needs to be overcome.

To overcome the foregoing disadvantages, the inventor(s) of the present invention based on years of experience in the related field to conduct extensive researches and experiments, and finally invented an assembly and disassembly device for a display monitor and method thereof, as a method or a basis for resolving the foregoing drawbacks.

### SUMMARY OF THE INVENTION

An object of the present invention is to provide an assembly and disassembly device for a display monitor. More particularly, a fastening manner is used, so that the display monitor can be assembled to and disassembled from a seat body easily.

In order to achieve the aforementioned object, the present invention provides an assembly and disassembly device for the display monitor. The assembly and disassembly device of the present invention comprises a lockup portion and a framework portion. The assembly and disassembly device can be used to connect the display monitor and the seat body, and the seat body can carry the display monitor.

The lockup portion has a locking body for connecting the seat body. The framework portion has a connecting body for connecting the display monitor.

The connecting body has an opening and a guiding slot. The opening is connected with the guiding slot. When a protruding body moves from the opening to the guiding slot, the lockup portion can be securely connected with the framework portion via a fastening body.

Another object of the present invention is to provide a method for assembling and disassembling a display monitor. The method is used to install the display monitor on a seat body having a containing slot, and comprises the steps of: (1) providing a lockup portion disposed in the containing slot and the lockup portion having at least a locking body extended along with a first direction; (2) providing a framework portion disposed on the display monitor and the framework portion having a connecting body that has an opening connected with a guiding slot toward a second direction; (3) leaning the display monitor upon the seat body based on the first direction so that the locking body can pass through the opening; and (4) moving the display monitor along with the second direction so that the locking body can enter into the guiding slot.

When the display monitor is removed from the seat body, the method further comprises the following steps of: (1) moving the display monitor along with the second direction, so that the locking body enters into the opening; and (2) moving the display monitor along with the first direction, so that the locking body can be removed from the opening.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a perspective view of a conventional pivot device for a display monitor.

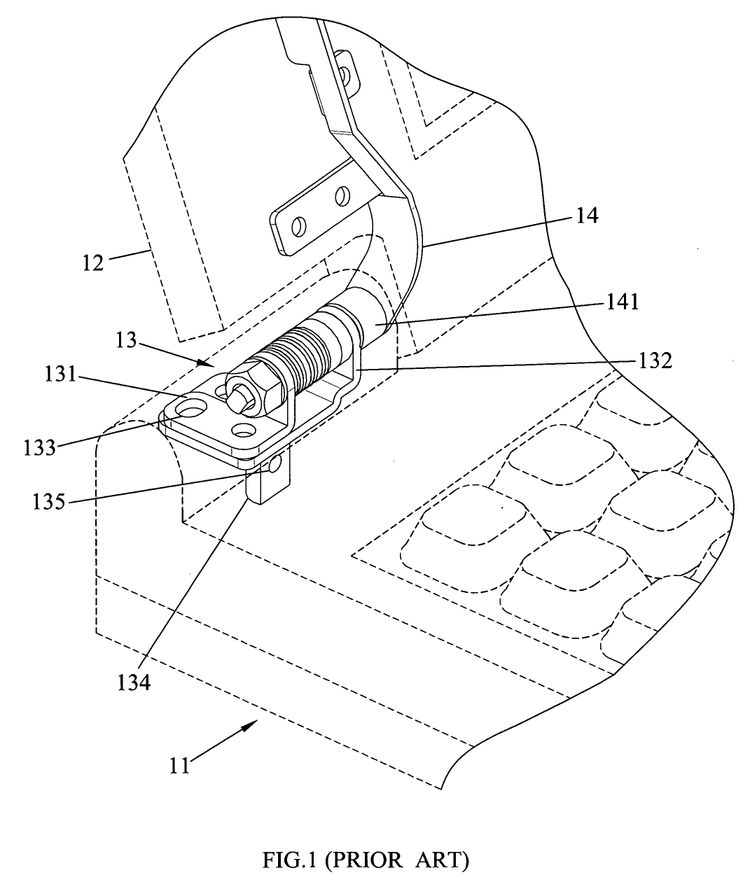

FIG. 2A is an exploded perspective view of an assembly and disassembly device for a display monitor of the present invention.

FIG. 2B is an enlarged view of a framework portion of a display monitor of the present invention.

FIG. 2C is an enlarged view of a lockup portion on the seat body of the present invention.

FIG. 2D is an assembled perspective view showing the assembly and disassembly device for a display monitor in accordance with the present invention.

FIG. 3A is a sectional view showing a stabilizing structure in an assembly and disassembly device according to a preferred embodiment of the present invention.

FIG. 3B is a sectional view showing the assembling operation in an assembly and disassembly device according to a preferred embodiment of the present invention.

FIG. 4A is a sectional view showing a stabilizing structure in an assembly and disassembly device according to another preferred embodiment of the present invention.

FIG. 4B is a sectional view showing the assembling operation in an assembly and disassembly device according to another preferred embodiment of the present invention.

FIG. 5A is a sectional view showing a stabilizing structure in an assembly and disassembly device according to a third preferred embodiment of the present invention.

FIG. 5B is a sectional view showing the assembling operation in an assembly and disassembly device according to a third preferred embodiment of the present invention.

FIG. 6 is a sectional view showing a stabilizing structure in an assembly and disassembly device according to a fourth preferred embodiment of the present invention.

FIG. 7 is a flow chart illustrating an assembly and disassembly method of the present invention.

### DETAILED DESCRIPTION OF THE PREFERRED EMBODIMENTS

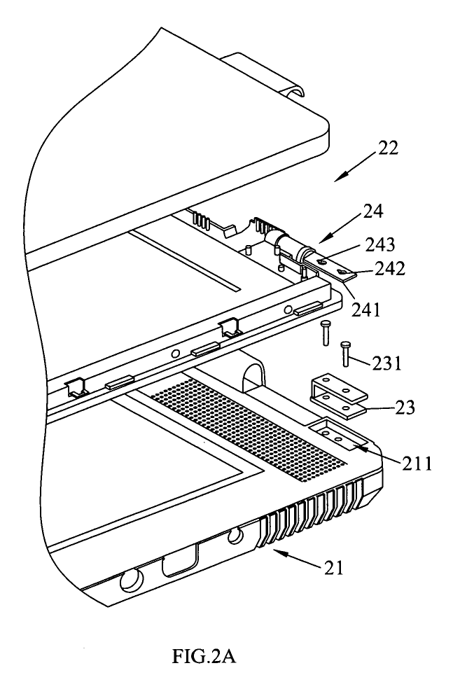

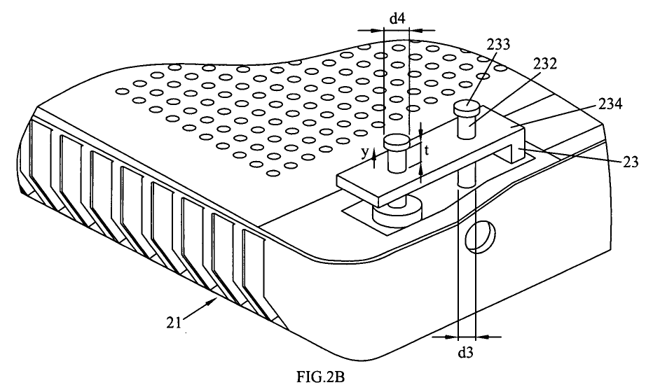

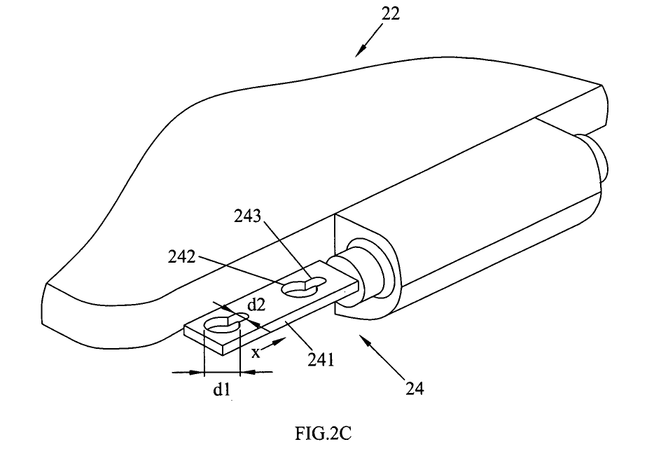

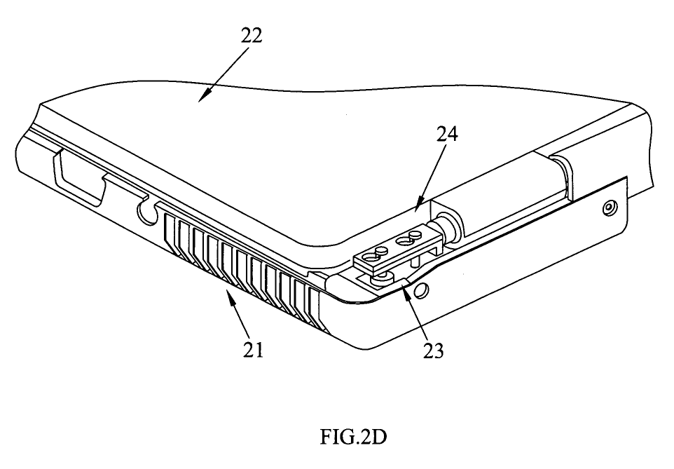

Referring to FIGS. 2A to 2D, FIG. 2A is an exploded perspective view of an assembly and disassembly device for a display monitor of the present invention, and FIG. 2B is an enlarged view of a framework portion, and FIG. 2C is an enlarged view of the lockup portion, and FIG. 2D is an assembled perspective view showing the assembly and disassembly device for the display monitor in accordance with the present invention. The assembly and disassembly device of the present invention is used for electronic devices having a foldable display monitor, such as notebook computers, portable telecommunication devices, Personal Digital Assistants (PDA) and Personal Navigation Devices (PND).

The electronic device includes a seat body 21 and a display monitor 22. The seat body 21 carries the display monitor 22 and has a containing slot 211. The assembly and disassembly device comprises a lockup portion 23 and a framework portion 24. The framework portion 24 is disposed on the display monitor 22, and has a connecting body 241, an opening 242 and a guiding slot 243. The opening 242 and the guiding slot 243 are disposed on the connecting body 241, and the opening 242 is connected with the guiding slot 243 along a second direction x, as shown in FIG. 2C. The opening 242 has a first dimension d1, and the guiding slot 243 has a second dimension d2.

The lockup portion 23 is installed and fastened in the containing slot 211 through at least a locking body 231. When the locking body 231 fastens the lockup portion 23, a protruding body 232 and a fastening body 233 of the locking body 231 are formed from a surface 234 of the lockup portion 23 along a first direction y, as shown in FIG. 2B. The protruding body 232 has a third dimension d3 while the fastening body 233 has a fourth dimension d4, and a distance t is further set between the fastening body 233 and the surface 234. In addition, the first dimension d1 is larger than the fourth dimension d4, and the second dimension d2 is slightly larger than the third dimension d3 but smaller than the fourth dimension d4.

When the assembly and the disassembly device of the present invention is used to assemble the display monitor 22 on the seat body 21, the display monitor 22 is connected with the seat body 21 along the first direction y, so that the fastening body 233 passes through the opening 242, and the protruding body 232 is located in the opening 242 to enable the connecting body 241 to be fastened into the locking body 231. Afterward the display monitor 22 moves along the second direction x, so that the protruding body 232 enters the guiding slot 243 from the opening 242. Because the fourth dimension d4 is larger than the second dimension d2, the fastening body 233 can be fastened to the connecting body 241 to achieve the efficiency of connecting the display monitor 22 and the seat body 21.

When the display monitor 22 is removed from the seat body 21, the display monitor 22 moves along the second direction x, so that the protruding body 232 can be removed from the guiding slot 243, and can enter into the opening 242. In the meantime, the display monitor 22 moves along the first direction y. Since the first dimension d1 is larger than the fourth dimension d4, the display monitor 22 can be removed from the seat body 21.

The assembly and disassembly device of the present invention can include a stabilizing structure upon demands. For example, a protrusion and a cavity (both are not shown in the figure), which correspond to each other, are disposed to a surface of the lockup portion and a bottom of the connecting body respectively. The stabilizing structure, which has an increased thickness, can be disposed on the surface of the lockup portion so as to increase the fastening strength of fastening the protruding body 232 to the guiding slot 243.

Alternatively, the skidproof is executed on the surface of the lockup portion or the bottom of the connecting body upon demands. For example, a slip-resistant layer can be coated on/adhere to the surface of the lockup portion or the bottom of the connecting body. Moreover, the surface of the lockup portion or the bottom of the connecting body is treated to become a rough surface to increase the friction between the lockup portion and the connecting body, thereby increasing the fastening strength.

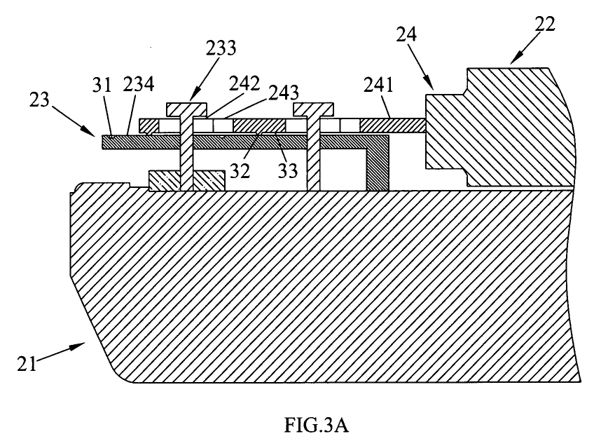

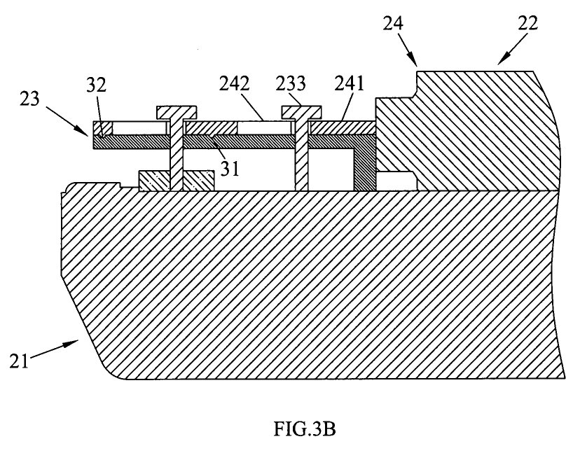

Referring to FIGS. 3A and 3B, FIG. 3A is a sectional view showing a stabilizing structure in an assembly and disassembly device according to a preferred embodiment of the present invention, and FIG. 3B is a sectional view showing the assembling operation of the present invention. Comparing with the embodiment of FIG. 2A, the surface 234 of the lockup portion 23 has a cavity 31 as shown in FIG. 3A, and a bottom 33 of the connecting body 241 has a protrusion 32. The bottom 33 is in contact with the surface 234. The protrusion 32 is located on the bottom 33 and corresponds to the cavity 31. When the display monitor 22 is assembled to the seat body 21 and moves along the second direction x, the protruding body 232 can move from the opening 242 to the guiding slot 243. The protrusion 32 can enter the cavity 31 along the second direction x. Since the protrusion 32 is fastened to the cavity 31, the lockup portion 23 and the connecting body 241 may not easily generate the relative displacement.

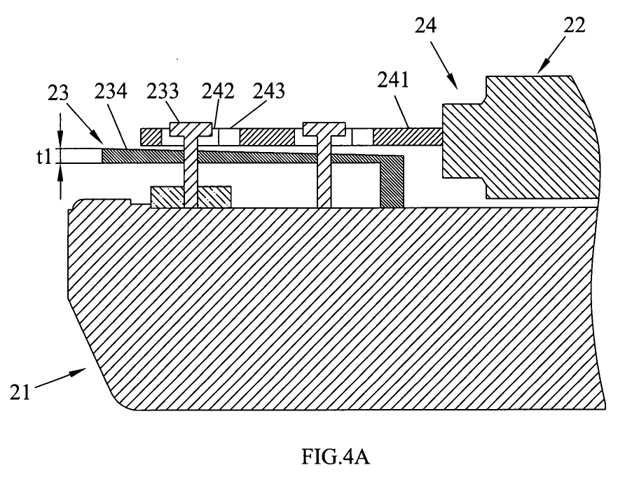

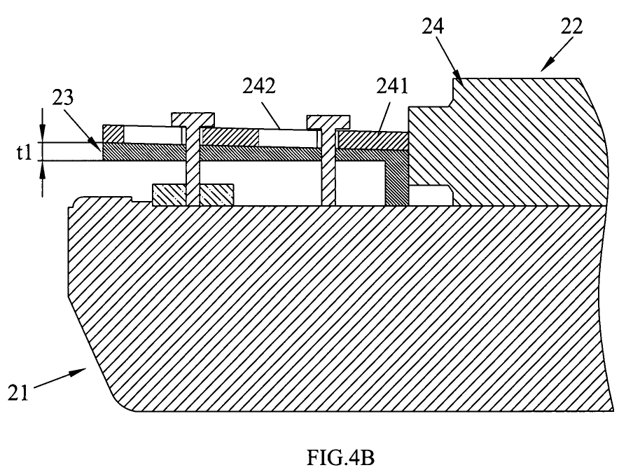

Referring to FIGS. 4A and 4B, FIG. 4A is a sectional view showing a stabilizing structure in an assembly and disassembly device according to another preferred embodiment of the present invention. FIG. 4B is a sectional view showing the assembling operation of the present invention. In contrast to the embodiment illustrated in FIG. 2A, the lockup portion 23 illustrated in FIG. 4A has a thickness t1 that enables the surface 234 of the lockup portion 23 to form an inclination. When the display monitor 22 is assembled to the seat body 21 and moves along the second direction x, the protruding body 232 can enter the guiding slot 243 from the opening 242. The connecting body 241 is further in contact with the surface 234 having the inclination. The force of pushing the connecting body 241 along the second direction x is transformed into the force of pressing the lockup portion 23 along the first direction y via the inclination, so that the lockup portion 23 and the connecting body 241 may not easily generate the relative displacement.

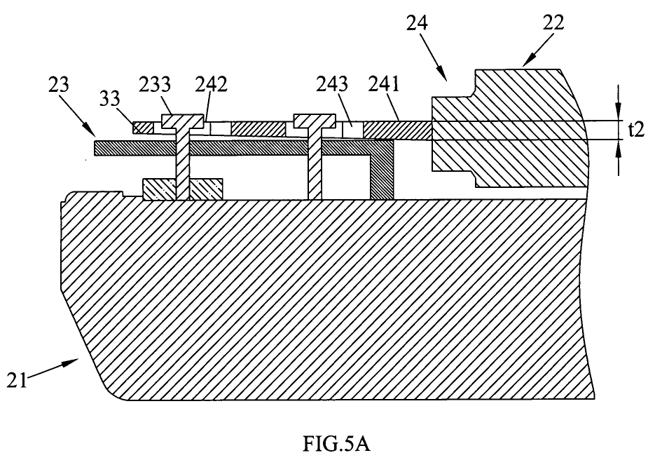

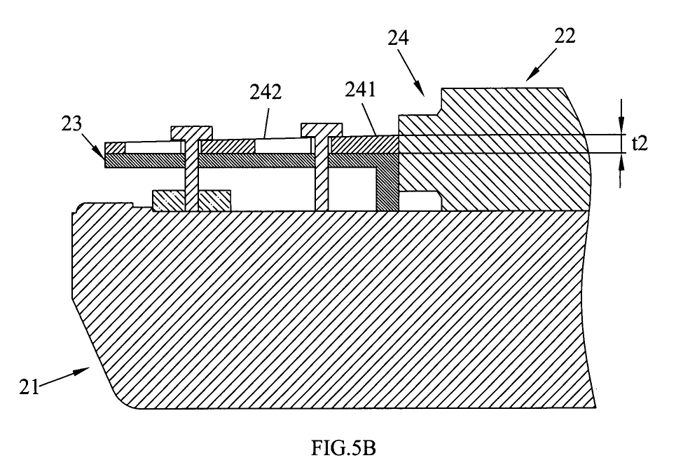

Referring to FIGS. 5A and 5B, FIG. 5A is a sectional view showing a stabilizing structure in an assembly and disassembly device according to a third preferred embodiment of the present invention. FIG. 5B is a sectional view showing the assembling operation of the present invention. In contrast to FIG. 2A, the connecting body 241 illustrated in FIG. 5A has a thickness t2 that enables the bottom 33 of the connecting body 241 to form an inclination. When the display monitor 22 is assembled to the seat body 21 and moves along the second direction x, the protruding body 232 can enter the guiding slot 243 from the opening 242. The lockup portion 23 is further in contact with the bottom 33 having the inclination. The force of pushing the connecting body 241 along the second direction x is transformed into the force of pressing the lockup portion 23 along the first direction y via the inclination, so that the lockup portion 23 and the connecting body 241 may not easily generate the relative displacement.

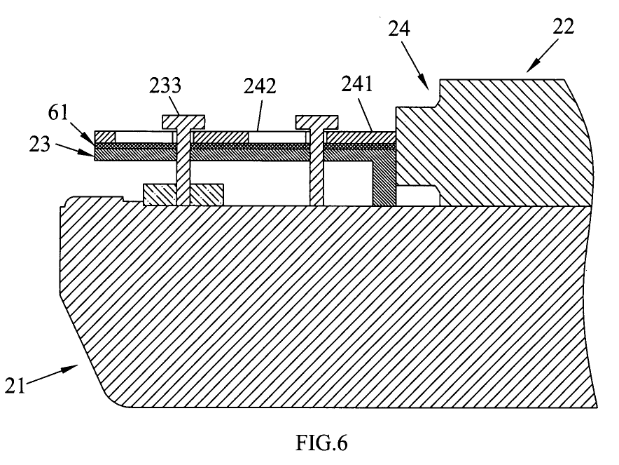

Referring to FIG. 6, FIG. 6 is a sectional view showing a stabilizing structure in an assembly and disassembly device according to a fourth preferred embodiment of the present invention. In contrast to FIG. 2A, the assembly and disassembly device further has a slip-resistant layer 61 as shown in FIG. 6. The slip-resistant layer 61 is disposed between the bottom 33 of the connecting body 241 and the surface 234 of the lockup portion 23. The slip-resistant layer 61 can be made of a material with a larger friction coefficient, such as rubber. When the display monitor 22 is assembled to the seat body 21 and moves along the second direction x, the protruding body 232 can enter the guiding slot 243 from the opening 242. The relative displacement between the lockup portion 23 and the connecting body 241 may not be easily generated through the slip-resistant layer 61.

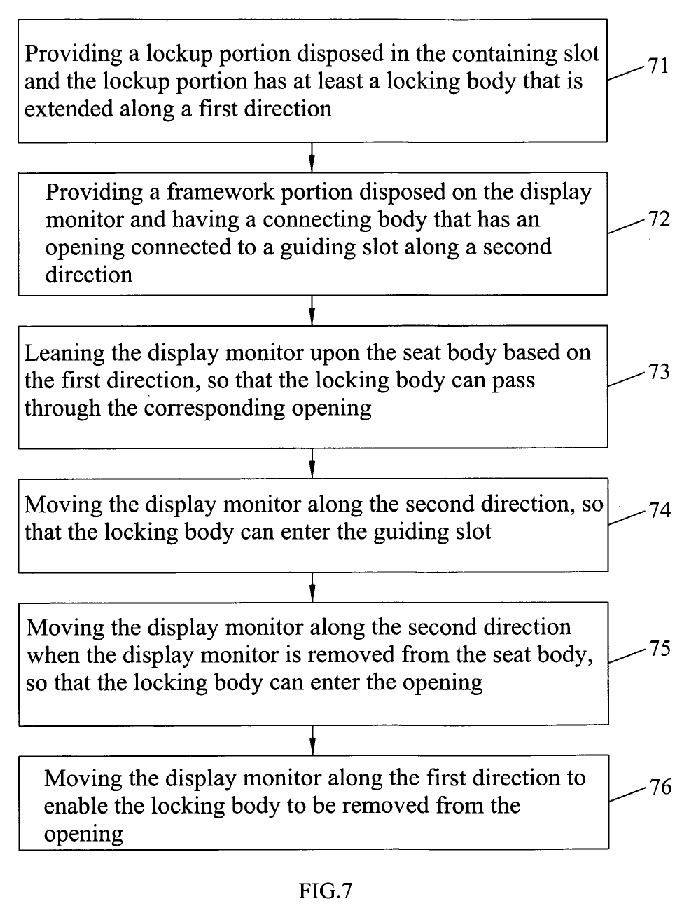

FIG. 7 is a flow chart illustrating an assembly and disassembly method of the present invention. The method is used to assemble a display monitor to a seat body, and the seat body has a containing slot. The method comprises the following steps:

Step 71: Providing a lockup portion disposed in the containing slot and the lockup portion has at least a locking body that is extended along a first direction.

Step 72: Providing a framework portion disposed on the display monitor and having a connecting body that has an opening connected to a guiding slot along a second direction.

Step 73: Leaning the display monitor upon the seat body based on the first direction, so that the locking body can pass through the corresponding opening.

Step 74: Moving the display monitor along the second direction, so that the locking body can enter the guiding slot.

Step 75: Moving the display monitor along the second direction when the display monitor is removed from the seat body, so that the locking body can enter the opening.

Step 76: Moving the display monitor along the first direction to enable the locking body to be removed from the opening.

The display monitor can be easily/rapidly assembled to and disassembled from the notebook computer to improve the efficiency of assembling and repairing the notebook computer through the foregoing illustration.

Although several preferred embodiments of the present invention have been described in detail hereinabove, it should be understood that the preferred embodiments are to be regarded in an illustrative manner rather than a restrictive manner, and all variations and modifications of the basic inventive concepts herein taught still fall within the scope of the present invention.

What is claimed is:

1. An assembly and disassembly device for a display monitor, the display monitor being capable of connecting a seat body to enable the seat body carry the display monitor, the assembly and disassembly device comprising:
a lockup portion having at least one locking body for connecting the seat body; and
a framework portion having at least one connecting body for connecting the display monitor,
wherein the connecting body has an opening and a guiding slot, and the opening is connected with the guiding slot, and when the locking body enters from the opening to the guiding slot, the lockup portion is securely fastened to the framework portion.

2. The assembly and disassembly device as claimed in claim 1, wherein the locking body is a bolt.

3. The assembly and disassembly device as claimed in claim 1, wherein the locking body has a protruding body, and the protruding body has a fastening body.

4. The assembly and disassembly device as claimed in claim 1, wherein the opening has a first dimension, and the guiding slot has a second dimension, and the first dimension is larger than the second dimension.

5. The assembly and disassembly device as claimed in claim 3, wherein the protruding body has a third dimension, and the fastening body has a fourth dimension, and the fourth dimension is smaller the first dimension but larger than the second dimension, and the third dimension is slightly smaller than the second dimension.

6. The assembly and disassembly device as claimed in claim 1, wherein the seat body has a cover body that is disposed on the assembly and disassembly device.

7. The assembly and disassembly device as claimed in claim 1, wherein the lockup portion has a cavity, and the connecting body has a protrusion, and when the lockup portion is fastened to the framework, the protrusion enters the cavity.

8. The assembly and disassembly device as claimed in claim 1, wherein the lockup portion has an inclination, so that a displacement is not easily generated between the lockup portion and the framework portion when the lockup portion is fastened to the framework portion.

9. The assembly and disassembly device as claimed in claim 1, wherein the connecting body has an inclination, so that a displacement is not easily generated between the lockup portion and the connecting body when the lockup portion is fastened to the connecting body.

10. The assembly and disassembly device as claimed in claim 1, further comprising a slip-resistant layer disposed between the framework portion and the lockup portion, so that the lockup portion and the framework portion do not easily generate a displacement when the framework portion is fastened to the lockup portion,.

11. A method of assembling and disassembling a display monitor, the method being capable of disposing the display monitor to a seat body, the seat body having containing slot, the method comprising the following steps:
(a) providing a lockup portion disposed in the containing slot, the lockup portion having at least a locking body extended along a first direction;
(b) providing a framework portion disposed on the display monitor, the framework portion having a connecting body, the connecting body having an opening connected to a guiding slot based on a second direction;
(c) leaning the display monitor upon the seat body based on the first direction to enable the locking body passing through the opening; and
(d) moving the display monitor along the second direction, so that the locking body enters the guiding slot.

12. The method as claimed in claim 11, wherein the step (d) further comprises the following steps:
(e) moving the display monitor along the second direction, so that the locking body enters the opening; and
(f) moving the display monitor along the first direction, so that the locking body is removed from the opening.
